(19) United States
(12) Patent Application Publication
(10) Pub. No.: US 2006/0011214 A1
(43) Pub. Date: Jan. 19, 2006

(54) System and method for pre-gate cleaning of substrates

(76) Inventors: Zhi (Lewis) Liu, Paoli, PA (US); Ismail Kashkoush, Orefield, PA (US); Alan Walter, Chester Springs, PA (US); Richard Novak, Plymouth, MN (US)

Correspondence Address: WOLF, BLOCK, SCHORR & SOLIS-COHEN LLP, 1650 ARCH STREET, 22ND FLOOR, PHILADELPHIA, PA, 19103-2334, US

(21) Appl. No.: 11/176,406

(22) Filed: Jul. 7, 2005

Related U.S. Application Data
(60) Provisional application No. 60/586,995, filed on Jul. 9, 2004.

(51) Int. Cl. C03C 23/00; B08B 3/00

(52) U.S. Cl. 134/2; 134/26; 134/94.1

(57) ABSTRACT

A system and method for cleaning semiconductor wafers wherein the use of SCI and SC2 is eliminated and replaced by the use DIO₃ and dilute chemistries. In one aspect, the invention is a method comprising: (a) supporting in a process chamber at least one semiconductor wafer having a silicon foundation with a silicon-dioxide layer in at least one pre-gate structure; (b) applying an aqueous solution of hydrofluoric acid in deionized (DI) water to the semiconductor wafer to remove the silicon dioxide layer and form a gate; (c) applying ozonated deionized water (DIO₃) to the semiconductor wafer to remove particles from the gate and passivate the silicon foundation; (d) applying a dilute solution of hydrofluoric acid and hydrochloric acid in DI water to the semiconductor wafer to remove any silicon dioxide layer that may have formed in the gate from the application of the DIO₃ and to remove any metal contaminants; and (e) applying DIO₃ to the semiconductor wafer to grow a new layer of silicon dioxide on the silicon foundation in the gate.

### CROSS-REFERENCE TO RELATED PATENT APPLICATIONS

The present application claims the benefit of U.S. Provisional Patent Application 60/586,995, filed Jul. 9, 2004, the entirety of which is hereby incorporated by reference.

### FIELD OF THE INVENTION

The present invention relates generally to the field of semiconductor manufacturing, and specifically to methods and systems for cleaning semiconductor wafers, and more specifically to methods and systems of pre-gate cleaning semiconductor wafers having small devices.

### BACKGROUND OF THE INVENTION

Conventionally in semiconductor manufacturing, wet cleaning of semiconductor uses the sequential chemical recipe of hydrofluoric acid (“HF”), Standard Clean 1 (“SC1”), and Standard Clean 2 (“SC2”) for pre-gate cleaning, which is referred to as the shorthand sequence HF+SC1+SC2. This cleaning sequence is designed to remove bulk silicon dioxide (“SiO₂”) by HF, followed by cleaning particles with SC1 (which is mixture of deionized (“DI”) water, ammonia hydroxide (“NH₄OH”), and hydrogen peroxide (“H₂O₂”)), and then to clean metals with SC2 (which is a mixture of DI water, hydrochloric acid (“HCl”) and H₂O₂). This sequential cleaning process is then typically followed by a final isopropyl alcohol (“IPA”) drying step. An intermediate DI water rinsing usually takes place between each step. It is important to clean the silicon (“Si”) surface of the semiconductor substrates after the HF and before the SC1 re-grows an SiO₂ layer. Any defects attributed to particles, metals or surface roughness in the Si—SiO₂ interface could cause the electric testing of oxide charge-to-breakdown (Q_{bd}) failure, resulting in device yield reduction.

The allowance of defects becomes very stringent as device size shrinks. Thus, the pre-gate clean becomes increasingly critical as it directly impacts the interface. A pre-gate cleaning recipe is typically required to accomplish three steps in the following order: (1) remove the top SiO₂ layer, typically in the range of 130 Å; (2) clean particulate and metallic contamination on the Si surface once the SiO₂ layer is removed with the creation of minimum surface roughness; and (3) re-grow a thin SiO₂ layer for the gate SiO₂ after the particulate and metallic contamination is cleaned from the Si surface.

Currently, pre-gate cleaning steps are accomplished through the use of the sequential chemical recipe of HF+SC1+SC2 (including a DI water rinse after each step). However, with the size of devices shrinking, this conventional cleaning recipes no longer satisfies industry requirements. Newer devices, which require thinner Si layers, are damaged by the SC1, and application of the sequential chemical recipe of HF+SC1+SC2 creates a low quality SiO₂ layer after cleaning. Thus, a new recipe and system for carrying out such a recipe is needed.

### SUMMARY OF THE INVENTION

It has been discovered that when the standard sequential recipe of HF+SC1+SC2 is used for pre-gate cleaning for 0.15 μm (and below) device wafers, low device yield emerges. It is believed that the low yield is caused by Si surface damage during the SC1 step and/or the creation of a low quality SiO₂ layer on the Si after the cleaning. The damage on the Si surface can include: (1) high Si surface roughness; and (2) SC1 pitting on the Si surface. Such pits are detectable as light point defects (“LPDs”). Therefore, it has been discovered that it is desirable to develop a cleaning system and method that eliminates SC1 from the recipe without reducing particulate and metallic removal capabilities. Additionally, the new cleaning system and method must create a high quality SiO₂ layer after the cleaning. Preferably, the cleaning system and method can be used for pre-gate cleaning. However, the invention, in some embodiments, will not be limited to pre-gate processes.

It is therefore an object of the present invention to provide a system and method for cleaning substrates.

A further object of the present invention is to provide a system and method for cleaning pre-gate structures on substrates.

A yet further object of the present invention is to provide a system and method for cleaning pre-gate structures on substrates that eliminates the use of SC2.

A still further object of the present invention is to provide a system and method for cleaning pre-gate structures on substrates that minimizes damage and/or re-grows a quality SiO₂ layer.

Another object of the present invention is to provide a system and method for cleaning substrates that eliminates the use of SC1.

Yet another object is to provide a system and method for pre-gate cleaning of semiconductor wafers for the production of 0.15 μm or smaller node of flash memory device.

Still another object of the present invention is to provide a system and method for pre-gate cleaning of semiconductor wafers for the production of 0.15 μm or smaller node of flash memory device that minimizes damage and/or re-grows a quality SiO₂ layer.

These and other objects are met by the present invention. In some embodiments, the system and method of the present invention utilizes a modification of the traditional sequential pre-gate cleaning recipe of HF+SC1+SC2 by using DIO₃ to replace the SC1 and/or using DIO₃ to re-grow the SiO₂ layer. In one embodiment, the modified recipe of the present invention comprises HF+DIO₃+dHF/HCl+DIO₃, wherein dHF/HCl stands for an diluted aqueous solution of HF and HCl. The use of this modified revision reduces Si surface damage and re-grows a high quality SiO₂ layer, without significantly reducing particulate and metallic removal. When used in conjunction with the pre-gate cleaning of 0.15 μm flash memory devices, the modified pre-gate cleaning recipe has shown to improve the yield of the production.

In one embodiment, the invention can be a system and method for carrying out a front end of line clean which is based on the mechanism of Si surface oxidation through the use of ozonated DI water (DIO₃), followed by the oxide etching by a mixture of dilute dHF/HCl, i.e. DIO₃+dHF/HCl. The dHF is to etch SiO₂ and the HCl is to clean metal contaminants. The invention has shown to work very well for particulate cleaning of particles as low as 0.1 μm size. Additionally, the invention works well for cleaning the metals down to as low as E9 atoms/cm² level. Repeating DIO₃+HF will not increase Si surface roughness and DIO₃ grows a better quality SiO₂ layer on the Si surface/foundation than the H₂O₂ in SC1. According to another embodiment of the present invention, the standard pre-gate clean recipe is modified by: (1) replacing the application of SC1 with DIO3; (2) replacing application of SC2 with dHF/HCl; and/or (3) adding DIO₃ in the last step of the recipe to grow a quality layer SiO₂. The modified recipe is the application of HF, followed by DIO3, followed by the mixture of dHF and HCl and followed by DIO3 again (i.e., HF+DIO3+dHF/HCl+DIO3). If desired, a DI water rinse can be performed after each step.

In one particular embodiment, the invention is a method of cleaning semiconductor wafers comprising the steps of: (a) supporting at least one semiconductor wafer in a process chamber; (b) applying an aqueous solution of hydrofluoric acid in deionized (DI) water to at least a first surface of the wafer; (c) rinsing the first surface with DI water; (d) applying ozonated deionized water (DIO₃) to the first surface; (e) rinsing the first surface with DI water; (f) applying a dilute solution of hydrofluoric acid and hydrochloric acid in DI water to the first surface; (g) rinsing the first surface with DI water; (h) applying DIO₃ to the first surface; and (i) rinsing the first surface with DI water; wherein steps (a) through (i) are performed sequentially.

Preferably, the aqueous solution of hydrofluoric acid applied in step (b) has a volumetric ratio in a range of 60 DI water:1 (49 wt % HF) to 100 DI water:1 (49 wt % HF), most preferably 50 DI water:1 (49 wt % HF). The aqueous solution of hydrofluoric acid in DI water of step (b) is also preferably performed for a time within the range of 100-175 seconds, most preferably 138 seconds. Additionally, the temperature of the aqueous solution of hydrofluoric acid in DI water applied in step (b) can be in the range of 10 to 40° C., with a preferred temperature of 25° C.

Regarding the application of the DI water in step (c), it is preferred that the DI water have a temperature within the range of 20 to 60° C. and be applied for a time in the range of 2 to 7 minutes, wherein the DI water rinse of step (c) is most preferably performed at 40° C. for 5 minutes.

The application of the DIO₃ in step (d) preferably has an ozone concentration within the range of 30 to 50 ppm of DI water, and most preferably 40 ppm. The application of the DIO₃ in step (d) is preferably performed for a time in the range of 4 to 8 minutes, and most preferably 6 minutes. It is further preferred that megasonic energy be applied to the semiconductor wafer during step (d) at a power in a range of 1200 to 1600 watts, and most preferably 1400 watts.

Regarding the application of DI water in step (e), the DI water is preferably applied for a time in the range of 2 to 6 minutes, with 4 minutes being most preferred. The temperature of the DI water in step (e) is preferred to be within the range of 20 to 60° C. and most preferably 40° C.

In some embodiments, the application of the dilute solution of hydrofluoric acid and hydrochloric acid applied in step (f) preferably has a volumetric ratio in a range of 300 DI water:1 (49 wt % hydrofluoric acid):2 (36 wt % hydrochloric acid) to 1200 DI water:1 (49 wt % hydrofluoric acid):2 (36 wt % hydrochloric acid), and most preferably 400 DI water:1 (49 wt % hydrofluoric acid):2 (36 wt % hydrochloric acid). Step (f) is preferably performed for a time in the range of 80 to 120 seconds, and most preferably 102 seconds. The dilute solution of hydrofluoric acid and hydrochloric acid in DI water is preferably maintained at a temperature in the range of 10 to 50° C., with 30° C. being most preferred.

Regarding the application of DI water in step (f), the DI water is preferably at a temperature within the range of 20 to 70° C., and more preferably 40 to 50° C. It is further preferable that megasonic energy be applied to the semiconductor wafer during step (f) at a power in a range of 1200 to 1600 watts, most preferably 1400 watts.

The DIO₃ applied to the semiconductor wafer in step (g) preferably has an ozone concentration in the range of 10 to 30 ppm of DI water, most preferably 20 ppm. Preferably, the temperature of the DIO₃ of step (g) is in the range of 10 to 50° C. and applied for a time of 4 to 8 minutes, and is most preferably applied at 30° C. for 6 minutes. Additionally, it is further preferred that megasonic energy be applied to the semiconductor wafer during step (g) at a power in the range of 1200 to 1600 watts, most preferably 1400 watts.

For the reasons discussed above, it is also preferred that SC1 not be used in the cleaning method of the inventions. The first surface of the semiconductor wafer preferably comprises devices in the range of 0.50 to 0.10 μm in size and have at least one gate to be cleaned.

In still another embodiment, the invention can be a method for pre-gate cleaning of semiconductor wafers comprising: (a) supporting in a process chamber at least one semiconductor wafer having a silicon foundation with a silicon-dioxide layer in at least one pre-gate structure; (b) applying an aqueous solution of hydrofluoric acid in deionized (DI) water to the semiconductor wafer to remove the silicon dioxide layer and form a gate; (c) applying ozonated deionized water (DIO₃) to the semiconductor wafer to remove particles from the gate and passivate the silicon foundation; (d) applying a dilute solution of hydrofluoric acid and hydrochloric acid in DI water to the semiconductor wafer to remove any silicon dioxide layer that may have formed in the gate from the application of the DIO₃ and to remove any metal contaminants; and (e) applying DIO₃ to the semiconductor wafer to grow a new layer of silicon dioxide on the silicon foundation in the gate. In this aspect, it preferable that a DI water rinse step be performed after each of steps (b) through (e) and that all steps be performed sequentially. As above, SC1 is preferably not used. Additionally, megasonic energy can be applied to any of the steps.

In yet another embodiment, the invention can be a method of processing semiconductor wafers comprising: (a) supporting in a process chamber at least one semiconductor wafer having at least one gate with a portion of a silicon foundation exposed; and (b) applying ozonated deionized water (DIO₃) to the silicon foundation to remove particles.

In a still further embodiment, the invention can be a method of processing semiconductor wafers comprising: (a) supporting in a process chamber at least one semiconductor having at least a portion of exposed silicon foundation in a gate; and (b) applying ozonated deionized water (DIO₃) to the exposed silicon foundation to grow a silicon dioxide layer in the gate.

In an even further embodiment, the invention can be a system for cleaning semiconductor wafers comprising: a process chamber; means for supporting at least one semiconductor wafer in the process chamber; means for applying an aqueous solution of hydrofluoric acid in DI water to at least a first surface of the wafer; means for applying deioinized (DI) water to the first surface; means for applying ozonated deionized water (DIO₃) to the first surface; means for applying a dilute solution of hydrofluoric acid and hydrochloric acid in DI water to the first surface; and a controller for sequentially applying (i) the aqueous solution of hydrofluoric acid in DI water to the first surface, (ii) the DI water to the first surface, (iii) the DIO₃ to the first surface, (iv) the DI water to the first surface, (v) the dilute solution of hydrofluoric acid and hydrochloric acid in DI water to the first surface; (vi) the DI water to the first surface, and (vii) the DIO₃ to the first surface.

It should be noted that the preferred aspects of the invention set forth above are not limiting of the scope of the invention but are intended to merely exemplify preferred embodiments of the invention. The true scope of the invention is to be determined from the claims.

### BRIEF DESCRIPTION OF THE DRAWINGS

FIG. 1 is a schematic of a cross-sectional view of a semiconductor wafer having a pre-gate structure.

FIG. 2 is a comparative graph showing Q_{bd} data of five different cleaning processes, including cleaning according to one embodiment of the present invention, the comparative graph plotting number of failures as a function of the oxide electric field which is a measure of the oxide quality.

FIG. 3 is a comparative diagram of flatband voltage (Vfb) data on 0.15 μm gate SiO₂ created by prior art cleaning process HF+SC1+SC2 vs. a cleaning process according to an embodiment of the present invention HF+DIO₃+dHF/HCl+DIO₃.

FIG. 4 is a comparative diagram showing Rutherford backscattering (RBS) data for a 0.15 μm gate SiO₂ subjected to a prior art cleaning process HF+SC1+SC2 vs. a cleaning process according to an embodiment of the present invention HF+DIO₃+dHF/HCl+DIO₃.

FIG. 5 is a schematic of a substrate cleaning system according to an embodiment of the present invention.

### DETAILED DESCRIPTION OF THE DRAWINGS

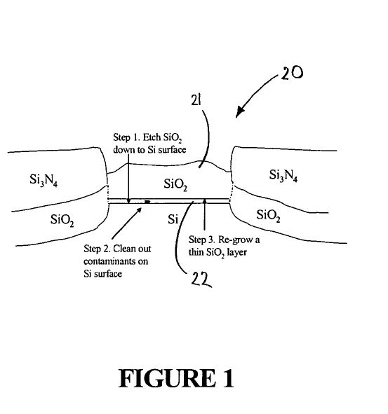

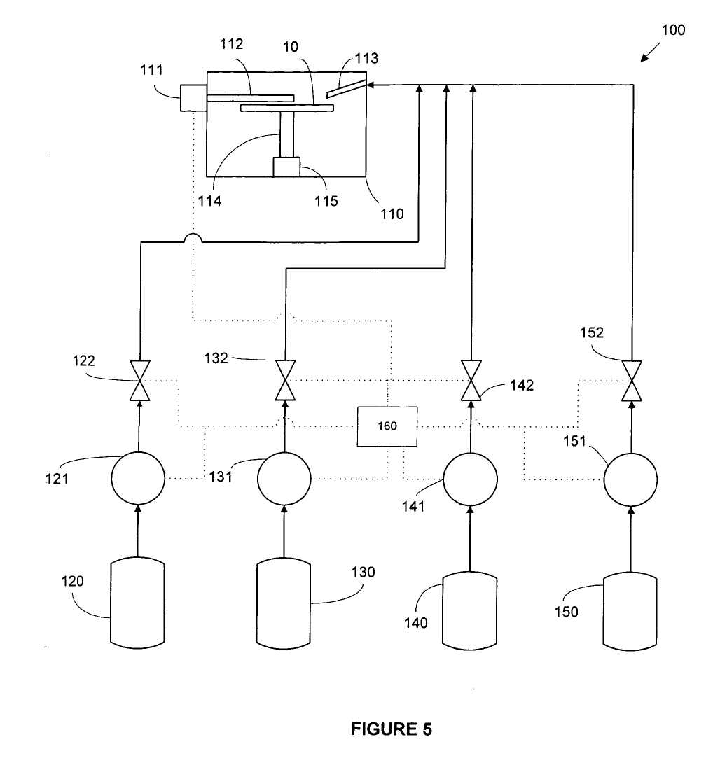

FIG. 1 is a schematic showing a cross-sectional view of a pre-gate structure 20 of approximately 0.15 μm node flash memory device on a semiconductor wafer. The present invention can be used to clean the pre-gate structure 20 of the semiconductor wafer. For ease of understanding, the pre-gate cleaning process will be described with reference to the system of FIG. 5 with the understanding the cleaning process is not limited by the system hardware and/or configuration, but can be carried out on variety of substrate cleaning systems, including both batch and single-substrate systems.

Referring now to FIG. 5, a pre-gate cleaning system 100 is illustrated according to an embodiment of the present invention. The pre-gate cleaning system 100 comprises a process chamber 110, a reservoir of an aqueous solution of hydrofluoric acid and DI water 120, a reservoir of DI water 130, a reservoir of dHF/HCL 140, a reservoir of DIO3 150, and a system controller 160. For ease of discussion and illustration, the pre-gate cleaning system 100 is illustrated having reservoirs 120, 130, 140, 150 of pre-mixed/formed processing fluids to carry out the inventive pre-gate cleaning method. However, the invention is not so limited. In some embodiments, any and/or all of the processing fluids can be formed/mixed on the fly during or prior to processing. Such mixing techniques and equipment are well known in the art.

For example, rather than providing a reservoir of an aqueous solution of hydrofluoric acid and DI water 120, a separate DI water reservoir and HF reservoir can be provided and the system controller 160 can be programmed to control the flow rates and mixers to mix the DI water and HF in the desired concentration to form the desired aqueous solution of hydrofluoric acid and DI water. Accordingly, similar techniques can be used to form/mix any and/or all of the mixtures/solutions used in the present invention. Those skilled in the art will understand how to incorporate the necessary pumps, ozone generators, mixers, valves, pipes, mass flow controllers, etc. to form the mixtures/solutions on the fly prior to or during the processing.

The pumps 121, 131, 141, 151 are operably coupled to the supply lines that are in turn fluidly coupled to the reservoirs 120, 130, 140, 150 in order to draw the respective fluids therefrom as needed during processing. When active, the pumps 121, 131, 141, 151 withdraw fluids from the reservoirs 120, 130, 140, 150, force the fluids through their respective supply lines, and into the process chamber 110 as needed. The valves 122, 132, 142, 152 are operably coupled to the supply lines downstream of the pumps 121, 131, 141, 151. The valves 122, 132, 142, 152 can be adjusted between an open position and a closed position to allow or prohibit the flow of the process fluids through the supply lines as needed. The valves 122, 132, 142, 152 are operably coupled to the system controller 160. As such, the system controller 160 can control which process fluid is supplied to the process chamber 110 and the timing of such supply.

As mentions above, the pre-gate cleaning system 100 comprises a properly programmed controller 160 so that the system 100 can be automated to carry out the pre-gate cleaning process according to the present invention. All of the hardware/components of the pre-gate cleaning system 100 are electrically and operably coupled to the controller, such as the valves 122, 132, 142, 152, megasonic energy source 111, the pumps 121, 131, 141, 151, and any mass flow controllers, inline heaters, inline coolers, and sensors that may be added to the system 100. The controller can be a suitable microprocessor based programmable logic controller, personal computer, or the like for process control. The system controller 160 preferably includes various input/output ports used to provide connections to the various components of the pre-gate cleaning system 100 that need to be controlled and/or communicated with. The system controller 160 also preferably comprises sufficient memory to store process recipes and other data, such as thresholds inputted by an operator, processing times, processing conditions, processing temperatures, flow rates, desired concentrations, sequence operations, and the like. The system controller 160 can communicate with the various components of the system 100 to automatically adjust process conditions, such as temperatures, mass flow rates, etc. as necessary. The type of controller depends on the needs of the system in which it is incorporated. The electrical connections are indicated in dotted line in FIG. 5.

The process chamber 110 is single-substrate process tank. However, the present invention can be performed in both batch-type immersion tanks and single substrate non-immersion chambers. Additionally, the semiconductor wafer can be supported in a substantially vertical or a substantially horizontal position during processing. The process chamber 110 comprises a substrate support 114, a motor 115, a sonic energy transmitter 112, a source of sonic energy 111, and a dispense nozzle 113. The source of sonic energy 111 can comprise a transducer which is operably coupled to the transmitter 112. When activated, the sonic energy source 111 creates sonic energy which is transmitted by the transmitter 112 to a substrate 10 which is supported on the support 114. The substrate can be rotated during processing by the motor 115.

The dispense nozzle 113 is used to supply the processing fluids to the surface of the substrate 10 so as to form a fluid coupling layer that couples the substrate surface to the transmitter 112. This facilitates the transmission of the sonic energy from the transmitter 112 to the surface of the substrate 10. While the transmitter 112 is illustrated as a probe-like structure, any transmitter configuration can be used with the present invention, including pie-shaped, plate-like, etc. Moreover, any substrate support can be used, including a platter, a chuck, a ring-like support, etc.

Referring now to FIGS. 1 and 5 simultaneously, a method of pre-gate cleaning a semiconductor wafer 10 according to an embodiment of the present invention will now be described. First, a semiconductor wafer 10 is supported on the support 114 of the process chamber 110 in a substantially horizontal orientation. The top surface of the wafer 10 preferably comprises one or more of the pre-gate structures 20 illustrated in FIG. 1. The wafer 10 is then rotated as an aqueous solution of HF is applied to the substrate's surface to remove the SiO₂ layer 21. The aqueous solution of HF is applied to the top surface of the wafer 10 via the nozzle 113. The aqueous solution of HF is supplied to the nozzle 113 by the controller 160, which opens the valve 122 and activates the pump 121, thereby drawing the aqueous solution of HF from the reservoir 120 and forcing it to the nozzle 113.

The aqueous solution of HF preferably has a volumetric ratio in a range of 60 DI water:1 (49 wt % HF) to 100 DI water:1 (49 wt % HF), and most preferably 50 DI water:1 (49 wt % HF). The application of the aqueous solution of HF is preferably performed for a time within the range of 100-175 seconds, most preferably 138 seconds. Additionally, the temperature of the aqueous solution of HF can be in the range of 10 to 40° C., with a preferred temperature of 25° C. The desired temperature can be controlled by incorporating a heater or chiller on the supply line.

While the invention is not limited to any specific process parameters, it is preferred that the application of the aqueous solution of HF be targeted to remove 130 A of an SiO₂ layer 21 (thermal oxide) from the pre-gate structure 20. This target, and the process parameters, may change depending on the exact processing needs of the devices and/or wafers being processed. The application of the aqueous solution of HF preferably removes all of the SiO₂ layer 21 from the pre-gate structure 20, thereby exposing the bare Si foundation 22 in the gate structure 20.

Upon the application of the aqueous HF solution being complete, the system controller 160 closes the valve 122, opens the valve 132, and activates the pump 131. As a result, the flow of the aqueous HF solution is stopped and DI water is drawn from the reservoir 130 and forced onto the wafer surface 10 via the nozzle 113. The motor 115 continuously rotates the wafer 10 during processing. This high flow DI water rinse is preferably applied to the semiconductor wafer 10 at a temperature within the range of 20 to 60° C. and for a time in the range of 2 to 7 minutes. Most preferably, this high flow DI water rinse is at 40° C. for 5 minutes. The rinsing is able to reach 18 Meg-ohm DI water resistivity at the end. The temperature can be controlled by properly incorporating a heater or chiller on the DI water supply line, which in turn can be controlled by the system controller 160. If desired, sonic energy can be applied to the wafer 10 during the DI water rinse to further effectuate cleaning.

Upon completion of the DI water rinse, the system control 160 closes the valve 132, opens the valve 142, and activates the pump 141. As a result, the DI water flow is stopped and DIO₃ is drawn from the reservoir 140 and supplied to the nozzle 113 for application to the top surface of the wafer 10. Also at this time, the system controller 160 activates the sonic energy source 111, which results in sonic energy being created and transmitted to the wafer surface via the transmitter 112 (and the DIO₃ coupling layer). As the DIO₃ is applied to the semiconductor wafer surface, the DIO₃ contacts the exposed bare silicon foundation 22 and facilitates the removal of particle and/or contaminants. The DIO₃ preferably has an ozone concentration of 30-50 ppm, and more preferably 40 ppm per DI water. The DIO₃ is preferably at a temperature of 20-40° C., and more preferably approximately 30° C. The DIO₃ is preferably applied for 4-8 minutes, and more preferably about 6 minutes. The sonic energy is preferably of a megasonic frequency and is applied to the semiconductor wafer 10 at a power of 1400 watts during the DIO₃ application. The DIO₃ application is targeted to passivate the exposed silicon foundation, which is hydrophobic, to hydrophilic by oxidizing the surface. Again, temperatures can be controlled through the use of inline heaters or inline chillers.

The DIO₃ application is followed by a 4 minute high flow DI water rinsing. This second DI water rinse is accomplished by the system controller 160 closing the valve 142, deactivating the sonic energy source 111, opening the valve 132, and activating the pump 131. As a result of these actions, the flow of DIO₃ and the creation of sonic energy is stopped. The DI water is drawn from the reservoir 130 and forced through the nozzle 113 for application to the wafer 10. The DI water of this second rinse is preferably maintained at a temperature of 40° C. and preferably reaches 18 Meg-ohm resistivity at the end. If desired, sonic energy can be applied to the wafer during the second rinse. All temperatures are controlled by inline heaters or chillers.

Once the second DI water rinse is completed, the system controller 160 closes the valve 132, opens the valve 152, and activates the pump 151. As a result of these actions, the DI water flow is stopped and the dilution solution of hydrofluoric acid and hydrochloric acid in DI water (dHF/HCl) is drawn from the reservoir 150 and forced onto the top surface of the wafer 10 via the nozzle 113. The dHF/HCl applied to the wafer 10 preferably has the volumetric ratio of 400 (DI water):1 (49 wt % HF):2 (36 wt % HCl) and is at a temperature of 30° C. The application of the dHF/HCl preferably occurs for 102 seconds and is targeted to remove 6 Å of the SiO₂ silicon dioxide (thermal oxide), which was formed by the previous DIO₃ application. More specifically, the dHF removes thermal oxide while the HCl removes unwanted metals from the gate.

Once the application of the dHF/HCl is complete, the system controller 160 closes the valve 152, opens the valve 132, activates the sonic energy source 111, and activates the pump 131 (if necessary). As a result, the flow of dHF/HCl is stopped and DI water is once again drawn from the reservoir 130 and applied to the top surface of the wafer 10 via the nozzle 113. Sonic energy is also created at this time and applied to the wafer 10 during the DI water rinse This high flow DI water rinse is preferably continued for 8 minutes at 45° C. The sonic energy is preferably applied with 1400 watts of energy and at a megasonic frequency.

Upon completing this third DI water rinse, a second application of DIO₃ is performed to grow a quality SiO₂ layer (not illustrated) on the bare silicon foundation 22. Preferably, this application of DIO₃ is coupled with the application of sonic energy. This step is achieved by the system controller 160 closing the valve 132, opening the valve 142, activating the sonic energy source 111, and activating the pump 141 (if necessary). This second application of DIO₃ is preferably at a lower ozone concentration than the first DIO₃ application. Specifically, this application of DIO₃ preferably has an ozone concentration under 20 ppm per DI water. The DIO₃ is applied at a temperature of 30° C. and for a time of 6 minutes. The sonic energy is applied at a power of 1400 watts during this DIO₃ application and at megasonic frequency. The application of the DIO₃ is targeted to grow 6-10 Å SiO₂.

Because the second application of the DIO₃ preferably contains a lower concentration of ozone than the first DIO₃ applciation, it may be necessary to provide a second DIO₃ supply reservoir containing DIO₃ with the desired lower ozone concentration. However, in embodiments of the invention where the DIO₃ is formed dynamically through the use of a pure DI water supply and a properly coupled ozone generator, the DIO₃ can be formed so as to have different ozone concentrations at different steps without the need for additional hardware. Systems and methods of creating DIO₃ and controlling the ozone concentration are well known in the art.

The second DIO₃ application is followed by an 8 minute high flow DI water rinsing at 40° C. This is accomplished by the system controller 160 closing the valve 142, opening the valve 132, deactivating the sonic energy source 111, and activating the pump 131 (if necessary). This results in the flow of the DIO₃ and the creation of the sonic energy to be stopped. Simultaneously, the DI water is drawn from the reservoir 130 and applied to the wafer 10 via the nozzle 113. If desired, sonic energy can be applied during this final rinsing step.

Subsequently, IPA drying can be performed to dry the semiconductor wafer, such as, a DI water slow draining with hot IPA vapor on top of the water, followed by a two minute hot N₂ blowing.

### Experiment

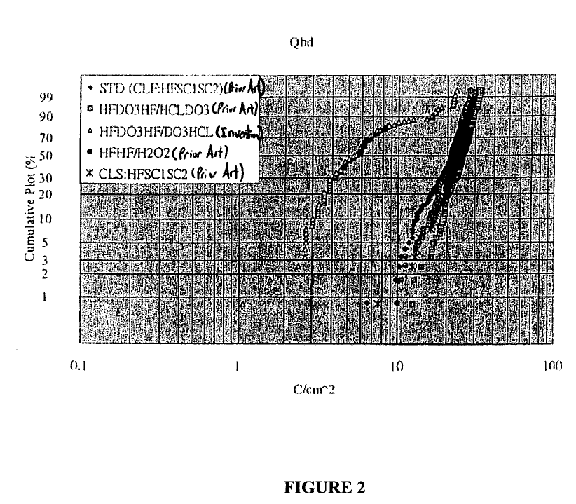

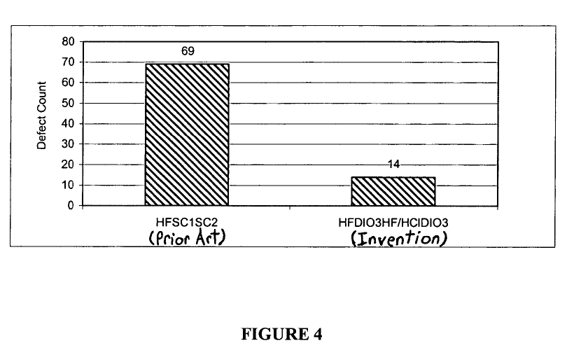

Experimental testing was carried out to verify the new modified pre-gate cleaning recipe of the present invention and to compare its electronic Qbd date with the standard prior art pre-gate clean. Along with the prior art recipe and the recipe of the present invention, four additional recipes were also tested. The cleaning tool used to perform the tests was a single-tank wet cleaning tool with one pass in-situ chemicals and DI water rinses. The wafers were the product of 0.15 μm flash memory device. The measurements of FIG. 2 were plotted using the Weibull charge-to-breakdown (Qbd) to evaluate gate oxide integrity. Flatband voltage (Vfb) measures oxide trapped charge in the Si—SiO2 interface as a function of oxide thickness and impurity. Observation of a low flatband voltage means that there is a thicker SiO₂ layer with less impurities. Rutherford Backscattering (RBS) is ideally suited for determining the concentration of trace elements on SiO₂ surface, and was used in the creation of FIG. 4. The five cleaning recipes performed in the experiment are summarized in details as follows:
1. PRIOR ART STANDARD CLEAN (“HF+SC1+SC2” or “STD(CLF:HFSC1SC2,” as named on FIG. 2)
This recipe is the standard pre-gate clean used for higher that 0.15 μm pre-gate cleaning. Its details in cleaning sequence are list as follows:
   1) The HF is in the volumetric ratio of 50 (DI water):1 (49% HF) at 25° C. for 138 seconds as it is targeted to remove 130 A of thermal oxide. The HF is followed by a high flow DI water rinsing for 5 minutes at 40° C. The rinsing is able to reach 18 Meg-ohm DI water resistivity at the end.
   2) The SC1 is in the volumetric ratio of 80 (DI water):2 (30 wt % NH₄OH):3 (29 wt %) at 45° C. with 1400 watts megsonic energy for 360 seconds as it is targeted to clean particles and light organic residues. The H₂O₂ in the SC1 is dispensed at 5 seconds prior to NH₄OH to passivate the hydrophobic Si surface before the NH₄OH. The SC1 is followed by a high flow DI water rinsing for 8 minutes at 45° C. with 1400 watts megsonic energy.
   3) The SC2 is in the volumetric ratio of 80 (DI water):1 (36 wt % HCl):2 (29 wt % H₂O₂) at 45° C. with 1400 watts megsonic energy for 360 seconds as it was targeted to clean metals. The SC2 was followed by a high flow DI water rinsing for 8 minutes at 45° C. with 1400 watts megsonic energy.
   4) The last IPA drying was started with a DI water slow draining with hot IPA vapor on top of the water, followed by two minute hot N₂ blowing.
2. CLEANING RECIPE OF THE PRESENT INVENTION (“HF+DIO₃+dHF/HCl+DIO₃” or “HFDO3HF/HClDO3,” as named on FIG. 2)
This is the pre-gate clean recipe according to an embodiment of the present invention for the 0.15 μm device. It uses DIO₃ instead of SC1.
   1) The HF and its flowing DI water rinsing are the same as in the standard clean.
   2) The DIO₃ is at 40 ppm at 30° C. for 6 minutes with 1400 watts megsonic energy. It is followed by 4 minute high flow DI water rinsing at 40° C. The rinsing reaches 18 Meg-ohm resistivity at the end. It is targeted to passivate the Si hydrophobic surface to hydrophilic by oxidizing the surface.
   3) The dHF/HCl is the mixture of dilute HF and HCl. Its experimental condition is the volumetric ratio of 400 (DI water):1 (49 wt % HF):2 (36 wt % HCl) at 30° C. for 102 seconds. It is targeted to remove 6 Å thermal oxide. The dHF/HCl is followed by high flow DI water rinsing for 8 minutes at 45° C. with 1400 watts megsonic energy.
   4) The second DIO₃ is at lower concentration. The DIO₃ is under 20 ppm at 30° C for 6 minutes with 1400 watts megsonic energy. It is followed by 8 minute high flow DI water rinsing at 40° C. It is targeted to grow 6-10 Å SiO₂
   5) The IPA drying is the same as in the standard clean.
3. TEST RECIPE NUMBER ONE (“HF+DIO₃+dHF/DIO₃+HCl” or “HFDO3HF/DO3HCl,” as named on FIG. 2)
This recipe was designed to test the impact of the mixed chemicals of dHF and DIO3 on the pre-gate cleaning.
   1) The HF and the following DI water rinsing are the same as in the standard clean.
   2) The DIO₃ is the same as the first DIO3 in the modified clean.
   3) The dHF/ DIO₃ is the volumetric ratio of 400 (DI water):1 (HF) plus 40 ppm DIO₃. It is held at 30° C. for 102 seconds. The targeted goal is to remove particles. This is followed by high flow DI water rinsing for 8 minutes at 45° C.
   4) The HCl is at the volumetric ratio of 200 (DI water):1 (36 wt % HCl) at 45° C. for 6 minutes. It is targeted to clean metals. The HCl is followed by a high flow DI water rinsing for 8 minutes at 45° C. with 1400 watts megsonic energy.
   5) The IPA drying was the same as in the standard clean
4. TEST RECIPE NUMBER TWO (“HF+dHF/H₂O₂” or “HFHF/H2O2,” as named on FIG. 2)
This recipe was designed to test the impact of the mixed chemicals of dHF and H2O2 on the pre-gate cleaning.
   1) The HF and the following DI water rinsing are the same as in the standard clean.
   2) The dHF/H2O2 is the mixture of volumetric ratio of 400 (DI water):1 (HF):2 (H2O2). It is at 30° C. for 102 seconds. It is targeted to clean particles. It is followed by high flow DI water rinsing for 8 minutes at 45° C.
   3) The IPA drying is the same as in the standard clean
5. STANDARD CLEAN WITHOUT MEGASONICS (“HF+SC1+SC2” or “SCL:HFSC1SC2,” as named in FIG. 2.)
This clean is the same as the standard clean, except the megsonic energy is turned off in both SC1 and the following DI water rinsing.

FIG. 2 illustrates the Weibull plots of Qbd data after the above five cleaning recipes were performed. It is a plot of number of failures as a function of the oxide electric field, which is a measure of the oxide quality. The plot shows that the SiO₂ after performing the pre-gate cleaning recipe according to the present invention (named HFDO3HF/HClDO3 in FIG. 2) shows the best result. The plot also shows that the pre-gate cleaning recipe according to the present invention (named HFDO3HF/HClDO3 in FIG. 2) also had the best Q_{bd} result. The rank from high to low for SiO₂ qualities after the five cleans was found to be as follows:
1) CLEANING RECIPE OF THE PRESENT INVENTION (HFDO3HF/HClDO3)
2) TEST RECIPE NUMBER TWO (HFHF/H2O2)
3) STANDARD CLEAN WITHOUT MEGASONICS (SCL:HFSC1SC2)
4) PRIOR ART STANDARD CLEAN (STD(CLF:HFSC1SC2))
5) TEST RECIPE NUMBER ONE (HFDO3HF/DO3HCl).

The Q_{bd} data confirmed that the modification made on the standard clean according to an embodiment of the present invention is correct, i.e., that using DIO₃ to replace SC1 and that using DIO₃ to grow the gate SiO₂. is an improvement. After the standard recipe (HF+SC1+SC2) was replaced by the recipe of the present invention (HF+DIO₃+dHF/HCl+DIO₃) in the production, the yield increased by 50%. This inventive recipe has been monitored in production and has shown good consistency. Surprisingly, the 1400 watts megsonic energy that was turned on in the two DIO₃ steps during application of the recipe of the present invention did not show any damages on the device wafers. 40 ppm DIO₃ was used in the first DIO3 recipe, because it was found that DIO₃ at high concentration had high particle removal capability. It is known that hydroxyl radicals (OH*) exist in DIO₃ and that the OH* etches Si substrate. The co-existence of etching Si by OH* and oxidizing Si by O₃ in DIO₃ could be the reason for the good particle removal by DIO₃.

Comparing the other three recipes with the present invention recipe, HF+DIO₃+dHF/HCl+DIO₃, it is belived that the HF+dHF/H₂O₂ recipe didn't grow thick enough SiO₂ for the Qbd testing, the second HF+SC1+SC2 recipe incurred the Si damages from SC1, even though the SC1 didn't have the megsonics, and the HF+DIO₃+dHF/DIO₃+HCl recipe didn't grow enough SiO₂, either. Plus the HCl might have chemical impurity problems, which made its Q_{bd} the worst.

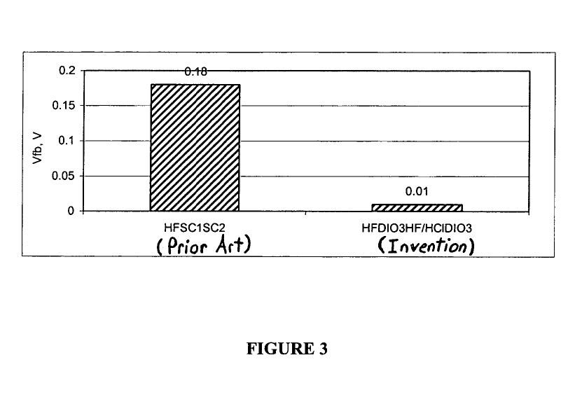

FIGS. 3 and 4 show more results V_{fb} and RBS measurements, respectively, in comparing the stand prior art recipe with the recipe of the present invention. FIG. 3 shows V_{fb} data. It shows that the recipe of the present invention, HF+DIO₃+dHF/HCl+DIO₃, had lower V_{fb} than the standard prior art recipe, HF+SC1+SC2. This indicates that the recipes of the present invention (with DIO₃) grew thicker SiO₂ than SC1 and SC2. FIG. 4 shows RBS data. It shows that the recipe of the present invention, HF+DIO₃+dHF/HCl+DIO₃, had lower defect count on the gate SiO₂ surface than the standard prior art recipe, HF+SC1+SC2.

Thus, it has been discovered that as the size of semiconductor device shrinks, the conventional pre-gate clean of HF+SC1+SC2 will no longer satisfy production yield requirements because of Si surface damage by SC1 and low quality SiO₂ grown in the cleaning of the gate oxide. The present invention, however, solves these problems by using DIO₃ to replace SC1 and by using DIO₃ to grow better SiO₂. It has been further discovered that only highly ozone concentrated DIO₃ was good for particulate removal. Perhaps, the high concentrated hydroxyl radicals (OH*) in DIO₃ might help in the removal, along with DIO₃+dHF/HCl in this cleaning.

While the invention has been described and illustrated in sufficient detail that those skilled in this art can readily make and use it, various alternatives, modifications, and improvements should become readily apparent without departing from the spirit and scope of the invention. Specifically, while the invention is described in terms of cleaning a pre-gate structure, this is just one example of the “critical cleans” that can be performed in accordance with the present invention. Moreover, in some embodiments, it may not be necessary to carry out a rinsing step in between each of the process steps. Furthermore, the in some embodiments of the invention, the megasonic energy may be applied to the side of the wafer that is opposite of the pre-gate structure devices.

What is claimed is:

1. A method of cleaning semiconductor wafers comprising:
(a) supporting at least one semiconductor wafer in a process chamber;
(b) applying an aqueous solution of hydrofluoric acid in deionized (DI) water to at least a first surface of the wafer;
(c) rinsing the first surface with DI water;
(d) applying ozonated deionized water (DIO₃) to the first surface;
(e) rinsing the first surface with DI water;
(f) applying a dilute solution of hydrofluoric acid and hydrochloric acid in DI water to the first surface;
(g) rinsing the first surface with DI water;
(h) applying DIO₃ to the first surface; and
(i) rinsing the first surface with DI water;
wherein steps (a) through (i) are performed sequentially.

2. The method of claim 1 wherein the aqueous solution of hydrofluoric acid in DI water of step (b) has a volumetric ratio in a range of 60 DI water:1 (49 wt % HF) to 100 DI water:1 (49 wt % HF).

3. The method of claim 1 wherein step (b) is performed for a time within a range of 100-175 seconds.

4. The method of claim 1 wherein temperature of the aqueous solution of hydrofluoric acid in DI water of step (b) is in the range of 10 to 40° C.

5. The method of claim 1 wherein temperature of the DI water of step (c) is in a range of 20 to 60° C.

6. The method of claim 1 wherein step (c) is performed for a time in a range of 2 to 7 minutes.

7. The method of claim 1 wherein the DIO₃ of step (d) has an ozone concentration within a range of 30 to 50 ppm of DI water.

8. The method of claim 1 wherein step (d) is performed for a time in a range of 4 to 8 minutes.

9. The method of claim 1 further comprising applying megasonic energy to the semiconductor wafer during step (d).

10. The method of claim 9 wherein the megasonic energy is applied at a power in a range of 1200 to 1600 watts.

11. The method of claim 1 wherein step (e) is performed for a time in a range of 2 to 6 minutes.

12. The method of claim 1 wherein the dilute solution of hydrofluoric acid and hydrochloric acid in DI water of step (f) has a volumetric ratio in a range of 300 DI water:1 (49 wt % hydrofluoric acid):2 (36 wt % hydrochloric acid) to 1200 DI water:1 (49 wt % hydrofluoric acid):2 (36 wt % hydrochloric acid).

13. The method of claim 1 wherein step (f) is performed for a time in a range of 80 to 120 seconds.

14. The method of claim 1 wherein the dilute solution of hydrofluoric acid and hydrochloric acid in DI water of step (f) has a temperature in a range of 10 to 50° C.

15. The method of claim 1 wherein step (g) is performed for a time in a range of 6 to 10 minutes.

16. The method of claim 1 wherein temperature of the DI water of step (g) is in a range of 20 to 70° C.

17. The method of claim 1 further comprising applying megasonic energy to the semiconductor wafer during step (g).

18. The method of claim 17 wherein the megasonic energy is applied at a power in a range of 1200 to 1600 watts.

19. The method of claim 1 wherein the DIO₃ of step (h) has an ozone concentration in a range of 10 to 30 ppm of DI water.

20. The method of claim 1 wherein step (h) is performed for a time in a range of 4 to 8 minutes.

21. The method of claim 1 wherein temperature of the DIO₃ of step (h) is in a range of 10 to 50° C.

22. The method of claim 1 further comprising applying megasonic energy to the semiconductor wafer during step (h).

23. The method of claim 22 wherein the megasonic energy is applied at a power in a range of 1200 to 1600 watts.

24. The method of claim 1 wherein SC1 is not used.

25. The method of claim 1 wherein the first surface of the semiconductor wafer comprises devices in a range of 0.50 to 0.10 μm in size.

26. A method for pre-gate cleaning of semiconductor wafers comprising:
(a) supporting in a process chamber at least one semiconductor wafer having a silicon foundation with a silicon-dioxide layer in at least one pre-gate structure;
(b) applying an aqueous solution of hydrofluoric acid in deionized (DI) water to the semiconductor wafer to remove the silicon dioxide layer and form a gate;
(c) applying ozonated deionized water (DIO₃) to the semiconductor wafer to remove particles from the gate and passivate the silicon foundation;
(d) applying a dilute solution of hydrofluoric acid and hydrochloric acid in DI water to the semiconductor wafer to remove any silicon dioxide layer that may have formed in the gate from the application of the DIO₃ and to remove any metal contaminants; and
(e) applying DIO₃ to the semiconductor wafer to grow a new layer of silicon dioxide on the silicon foundation in the gate.

27. The method of claim 25 wherein a DI water rinse step is performed after each of steps (b) through (e).

28. The method of claim 25 wherein megasonic energy is applied to the semiconductor wafer during step (c).

28. The method of claim 25 wherein megasonic energy is applied to the semiconductor wafer during step (e).

29. The method of claim 25 wherein steps (a) through (e) are performed sequentially with a DI water rinse after each of steps (b) through (e).

30. The method of claim 25 wherein SC1 is not used.

31. The method of claim 25 wherein the DIO₃ applied in step (c) has an ozone concentration in a range of 30 to 50 ppm of DI water.

32. The method of claim 25 wherein the DIO₃ applied in step (e) has an ozone concentration in a range of 10 to 30 ppm of DI water.

33. A method of processing semiconductor wafers comprising:
(a) supporting in a process chamber at least one semiconductor wafer having at least one gate with a portion of a silicon foundation exposed; and
(b) applying ozonated deionized water (DIO₃) to the silicon foundation to remove particles.

34. A method of processing semiconductor wafers comprising:
(a) supporting in a process chamber at least one semiconductor having at least a portion of exposed silicon foundation in a gate; and
(b) applying ozonated deionized water (DIO₃) to the exposed silicon foundation to grow a silicon dioxide layer in the gate.

35. A system for cleaning semiconductor wafers comprising:
a process chamber;
means for supporting at least one semiconductor wafer in the process chamber;
means for applying an aqueous solution of hydrofluoric acid in DI water to at least a first surface of the wafer;
means for applying deioinized (DI) water to the first surface;
means for applying ozonated deionized water (DIO₃) to the first surface;
means for applying a dilute solution of hydrofluoric acid and hydrochloric acid in DI water to the first surface; and
a controller for sequentially applying (i) the aqueous solution of hydrofluoric acid in DI water to the first surface, (ii) the DI water to the first surface, (iii) the DIO₃ to the first surface, (iv) the DI water to the first surface, (v) the dilute solution of hydrofluoric acid and hydrochloric acid in DI water to the first surface; (vi) the DI water to the first surface, and (vii) the DIO₃ to the first surface.
